(19) United States
(12) Patent Application Publication
(10) Pub. No.: US 2016/0199826 A1
(43) Pub. Date: Jul. 14, 2016

(54) Process for Manufacturing a Product Containing a Catalytically Active Titanium Compound

(71) Applicant: SOLVAY ACETOW GMBH, Freiburg (DE)

(72) Inventors: Dirk HÖLTER, Emmendingen (DE); Armin STEIN, Kenzingen (DE)

(21) Appl. No.: 14/911,535

(22) PCT Filed: Jul. 31, 2014
(86) PCT No.: PCT/EP2014/066529

§ 371 Date: Feb. 11, 2016

(30) Foreign Application Priority Data
Aug. 12, 2013 (EP) 13180138.3

(51) Int. Cl. B01J 31/06; B01J 31/38

(52) U.S. Cl. CPC B01J 31/06; B01J 31/38

(57) ABSTRACT

Process for the manufacture of a product containing a catalytically active titanium compound, which comprises at least one step wherein the catalytically active titanium compound is contacted with a substrate in a liquid phase comprising a solvent having a carbonyl function and a C—H bond in α-position to said carbonyl function, and an inhibitor selected from one or more acids and one or more alcohols or mixtures thereof and product obtained by the process.

This application claims priority to European application No. 13180138.3, the whole content of this application being incorporated herein by reference for all purposes.

The present invention relates to a process for the manufacture of a product containing a catalytically active titanium compound and to a product containing a substrate and a catalytically active titanium compound.

Products containing catalytically active titanium compounds have been proposed to provide improved degradability of substrates such as cellulose acetate used as filter tow; see WO 2010/017989 in the name of the Applicant. The present invention now makes available an improved manufacturing process of a product containing a catalytically active titanium compound and improved products containing a substrate and a catalytically active titanium compound.

The invention concerns in consequence a process for the manufacture of a product containing a catalytically active titanium compound, which comprises at least one step wherein the catalytically active titanium compound is contacted with a substrate in a liquid phase comprising a solvent having a carbonyl function and a C—H bond in α-position to said carbonyl function, and an inhibitor selected from one or more acids and one or more alcohols or mixtures thereof.

It has been found, surprisingly, that the process according to the invention allows to strongly reduce the formation of undesired by-products, in particular from the autocondensation of solvent, while retaining desired catalytic activity of titanium compounds, e.g. for accelerating degradation, in particular photocatalytic degradation of substrates such as biobased polymers.

“Catalytically active titanium compound” is understood to denote in particular a titanium compound which is capable of accelerating reactions such as for example cleavage of organic compounds such as in particular biobased polymers. A particular class of catalytically active titanium compounds, so called photocatalytically active titanium compounds in particular titanium dioxide photocatalysts, is significantly catalytically active in presence of radiation such as visible light or UV light. TiO2 pigments containing coatings reducing the photocatalytical activity are no photocatalytically active titanium compounds in the sense of this invention. Preferred catalytically titanium compounds are nano-structured.

“Nano-structured” is understood to denote that the titanium compound consists or consists essentially of optionally agglomerated crystallites having an average particle size of from 1 to 150 nm, preferably from 1 to 100 nm, and more preferably from 5 to 30 nm.

Optionally modified nano-structured titanium dioxide is particularly preferred as catalytically active titanium compound.

In a first specific embodiment, the catalytically active titanium compound is a nano-structured titanium oxide comprising one or two types of titanium oxide, in particular rutile and/or anatase.

In a second specific embodiment, the catalytically active titanium compound is a nano-structured titanium oxide modified with additional elements such as carbon, nitrogen, sulfur, fluorine, iodine, aluminum, bismuth, iron, cobalt, vanadium, chromium, nickel, manganese, tungsten, molybdenum, tantalum, niobium, silver, gold or platinum. Carbon-modified nano-structured titanium oxide, such as disclosed in WO-A-2010/017989 in the name of the Applicant and iron modified titanium dioxide as disclosed in WO-A-2012/139726 are preferred.

When carbon-doped titanium dioxide is used, the crystallite size of the carbon-doped titanium dioxide can be from 5 to 150 nm, especially from 7 to 25 nm. In an individual case, it may be advantageous or even necessary to grind a conventional commercial coarse-particle carbon-modified titanium dioxide in order to adjust the optimal grain size.

Often, the carbon-modified titanium dioxide has a density (ISO 787,

Part 10) of 3.0 to 5.0 g/cm³ especially of 3.5 to 4.2 g/cm³. The carbon-modified titanium oxide has preferably a specific surface area BET of greater than 100 m²/g, especially greater than 250 m²/g. Often, this specific surface area is equal to or lower than 1000 m²/g. Preferably, the carbon-modified titanium dioxide is characterised by a significant light absorption compared to pure titanium dioxide in the range of [λ]>=400 nm.

The carbon-modified titanium dioxide preferably contains carbon in a quantity of 0.05 to 5% by weight, especially from 0.3 to 1.5% by weight.

In the process according to the invention, the solvent is often selected from ketones and esters, having a C—H bond in α-position to the carbonyl function. A ketone solvent is preferred, a C3-C6 ketone, in particular acetone, is more particularly preferred.

In one aspect, the inhibitor is the solvent which is comprised in the liquid phase. In another aspect, the solvent which is comprised in the liquid phase is different from the inhibitor.

In a first particular aspect of the process according to the invention, the inhibitor comprises an acid. Carboxylic acids are suitably used as inhibitors. Hydroxycarboxylic acids are preferred inhibitors. More particularly, an inhibitor selected from glycolic acid, lactic acid, malic acid, citric acid, tartaric acid, glyceric acid, hydracrylic acid, hydroxybutyric acid, mandelic acid or a combination thereof is preferred.

In a second particular aspect of the process according to the invention, the inhibitor comprises an alcohol. Polyols are preferred inhibitors. More particularly, an inhibitor selected from ethylene glycol, glycerol, propylene glycol, butanediol, pentaerythritol sugar alcohols or a combination thereof is preferred.

In the process according to the invention, the substrate is suitably a plastic material, in particular an optionally modified biopolymer. Preferably the plastic material is a photocatalytically degradable plastic material. Preferably, the substrate is an acylated polysaccharide such as acylated starch or, in particular, acylated cellulose.

When a cellulose ester is used as the substrate, cellulose acetate, cellulose propionate, cellulose butyrate, cellulose acetate propionate and/or cellulose acetate butyrate are preferred. Cellulose acetate is particularly preferred.

When a cellulose ester is used as the substrate, the average degree of substitution (DS) is preferably from 1.5 to 3.0, especially from 2.2 to 2.7, this especially being the case with the cellulose acetate. The optimal average degree of polymerisation in the cellulose ester is from 150 to 500, especially from 180 to 280.

In the process according to the invention, the amount of acid used as inhibitor is generally from 0.5 to 50% weight relative to the weight of catalytically active titanium compound. Preferably this amount is from 1 to 20% weight.

In the process according to the invention, the amount of alcohol used as inhibitor is generally from 0.5 to 1000% weight relative to the weight of catalytically active titanium compound. Preferably this amount is from 1 to 100% weight.

Generally, the liquid phase contains up to 4% weight of inhibitor and catalytically active titanium compound relative to the weight of the liquid phase. Preferably this amount is from 0.2-1% weight.

In the process according to the invention, the concentration of substrate is generally from 10 to 50% weight, preferably from 20 to 35% weight, relative to the total weight of the liquid phase.

In the process according to the invention, the concentration of solvent is generally from 49 to 89% weight, preferably from 64 to 79% weight, relative to the total weight of the liquid phase.

In particular aspects, the liquid phase contains up to 2% weight relative to the total weight of the liquid phase of additional additives such as stabilizers, colorants or pigments.

In a second particular aspect, the liquid comprises up to 10% of softeners.

The process according to the invention is usually carried out at a temperature from 50 to 65° C.

The liquid phase can be suitably processed by extrusion through a die to form films or filaments of substrate.

In a particular aspect, the process according to the invention comprises (a) providing a liquid phase comprising catalytically active titanium compound, solvent and inhibitor and (b) adding the liquid phase obtained in step (a) to a second liquid phase comprising the substrate and solvent and optionally (c) extruding liquid phase obtained in step (b) through a die to form films or preferably filaments of product containing substrate, catalytically active titanium compound and inhibitor.

In another particular aspect, the process according to the invention comprises (a) providing a liquid phase comprising catalytically active titanium compound, solvent, inhibitor and a first quantity of substrate and (b) adding at least a portion of the liquid phase obtained in step (a) to a second liquid phase comprising a second quantity of substrate and solvent and optionally (c) extruding liquid phase obtained in step (b) through a die to form films or preferably filaments of product containing substrate, catalytically active titanium compound and inhibitor. “First quantity” intends to denote an amount from 0.1 to 10% weight, preferably from 1 to 9% weight, and most preferably from 2 to 7% weight of substrate relative to the total weight of the liquid phase obtained in step a).

The invention also concerns a product containing a substrate, a catalytically active titanium compound, and an inhibitor selected from one or more acids and one or more alcohols or mixtures thereof, which can suitably be obtained through the process according to the invention.

The product according to the invention generally contains from 50 to 100000 ppm/wt, preferably from 100 to 2000 ppm/wt of inhibitor.

The product according to the invention generally contains less than 1000 ppm/wt, preferably less than 300 ppm/wt, more preferably less than 200 ppm/wt of autocondensation product of solvent, in particular diacetone alcohol. The product according to the invention generally contains more than 1 ppm/wt of autocondensation product of solvent, in particular diacetone alcohol.

The product according to the invention generally contains less than 10000 ppm/wt, preferably less than 5000 ppm/wt of solvent, in particular acetone. The product according to the invention generally contains more than 10 ppm/wt of solvent, in particular acetone.

The content of catalytically active titanium compound, in particular, carbon-modified titanium in the product according to the invention is generally from 0.1 to 5% by weight, especially to 0.3 to 1.5% by weight.

The product according to the invention may be transformed into moulded bodies, such as fibres, films, especially deep-drawn films, above all for use as packaging materials, for injection-moulded articles, thick-walled moulded bodies, granulates, microbeads, beads and vessels. The further processing of these fibres into filter tows is especially advantageous, with which filter rods and filter plugs made therefrom for filter cigarettes are produced. Filter plugs containing a catalytically active titanium compound, which are found in the environment, are degraded significantly faster with the action of light than those, which do not contain a catalytically active titanium compound. The moulded bodies such as fibres, films, especially deep-drawn films, packaging materials, injection-moulded articles, granulates, microbeads, beads, vessels, and, in particular, filter plugs, have a strongly reduced content of undesired by-products, in particular from the autocondensation of solvent, while retaining desired catalytic activity of titanium compounds, e.g. for accelerating degradation of the products. Should the disclosure of any patents, patent applications, and publications which are incorporated herein by reference conflict with the description of the present application to the extent that it may render a term unclear, the present description shall take precedence.

The examples hereinafter are intended to illustrate the invention without however limiting it.

### EXAMPLES

### Example 1 (Reference)

200 ml of acetone and 5% weight of a carbon modified TiO2 photocatalyst were mixed in a lightproof flask. The resulting suspension was stirred at 200 rpm at ambient temperature.

### Example 2

0.5% weight of propandiol were added to a mixture of 200 ml of acetone and 5% weight of a carbon modified TiO2 photocatalyst in a lightproof flask. The resulting suspension was stirred at 200 rpm at ambient temperature.

### Example 3

0.5% weight of glycerol were added to a mixture of 200 ml of acetone and 5% weight of a carbon modified TiO2 photocatalyst in a lightproof flask. The resulting suspension was stirred at 200 rpm at ambient temperature.

### Example 4

0.5% weight of lactic acid were added to a mixture of 200 ml of acetone and 5% weight of a carbon modified TiO2 photocatalyst in a lightproof flask. The resulting suspension was stirred at 200 rpm at ambient temperature.

### Example 5

0.5% weight of citric acid were added to a mixture of 200 ml of acetone and 5% weight of a carbon modified TiO2 photocatalyst in a lightproof flask. The resulting suspension was stirred at 200 rpm at ambient temperature.

### Example 6

5% weight of a carbon modified titanium dioxide were mixed with 3% weight cellulose acetate, 0.5% weight glycerol and remainder acetone. The resulting suspension was grinded using a pearl mill (WAB Dynomill Multilab, 1.4 l ).

26 parts by weight of a cellulose acetate with a DS of 2.45 were dissolved in 74 parts by weight of a solvent mixture of acetone/water 96:4. To this mixture 5.2% weight of the titanium dioxide suspension were added.

The resulting spinning dope was homogenized and subsequently filtrated.

Fibres with 3.0 denier filaments were produced from this spinning dope by dry spinning procedure.

### Example 7

5% weight of a carbon modified titanium dioxide were mixed with 3% weight cellulose acetate, 0.5% weight lactic acid and the remainder acetone. The resulting suspension was grinded using a pearl mill (WAB Dynomill Multilab, 1.4 l).

26 parts by weight of a cellulose acetate with a DS of 2.45 were dissolved in 74 parts by weight of a solvent mixture of acetone/water 96:4. To this mixture 5.2% weight of the titanium dioxide suspension were added.

The resulting spinning dope was homogenized and subsequently filtrated.

Fibres with 3.0 denier filaments were produced from this spinning dope by dry spinning procedure.

From examples 1 to 5 a sample was taken after 22 hours, filtrated and analyzed by gas chromatography.

The filter tow from example 6 was extracted with ethanol and the extract analyzed by gas chromatography.

The results are summarized in Table 1.

TABLE 1

| | mg diacetone | mg diacetone |
|---|---|---|
| Example | alcohol/l acetone | alcohol/kg fibres |
| 1 | 2280 | |
| 2 | 55 | |
| 3 | 1 | |
| 4 | 11 | |
| 5 | 2 | |
| 6 | | 60 |
| 7 | | 25 |

1-17: (canceled)

18. A process for manufacturing a product comprising a catalytically active titanium compound, the process comprises at least one step wherein the catalytically active titanium compound is contacted with a substrate in a liquid phase comprising a solvent having a carbonyl function and a C—H bond in α-position to said carbonyl function, and an inhibitor selected from one or more acids, one or more alcohols, or mixtures thereof.

19. The process according to claim 18, wherein the catalytically active titanium compound is a nano-structured titanium compound.

20. The process according to claim 18, wherein the catalytically active titanium compound is carbon-modified titanium dioxide.

21. The process according to claim 18, wherein the solvent is a ketone.

22. The process according to claim 18, wherein the inhibitor comprises a hydroxycarboxylic acid.

23. The process according to claim 18, wherein the inhibitor comprises an alcohol.

24. The process according to claim 18, wherein the substrate is a biopolymer.

25. The process according to claim 18, which comprises adding a liquid phase comprising the catalytically active titanium compound, the solvent, the inhibitor, and optionally a first quantity of substrate, to a second liquid phase comprising a second quantity of substrate and solvent.

26. The process according to claim 25, wherein the first quantity of substrate is from 0.1 to 10% weight of substrate relative to the total weight of the liquid phase.

27. The process according to claim 18 comprising from 0.5 to 50% weight of acid as the inhibitor, relative to the weight of catalytically active titanium compound, or from 0.5 to 1000% weight of alcohol as the inhibitor, relative to the weight of catalytically active titanium compound.

28. The process according to claim 18 comprising from 10 to 50% weight of the substrate, relative to the total weight of the liquid phase.

29. A product comprising the substrate, the catalytically active titanium compound, and the inhibitor selected from one or more acids, one or more alcohols, or mixtures thereof, obtained according to the process according to claim 18.

30. The product according to claim 29 comprising from 0.1 to 5% wt of the catalytically active titanium compound.

31. The product according to claim 29 comprising from 50 to 100000 ppm/wt of the inhibitor.

32. The product according to claim 29 comprising less than 1000 ppm/wt of autocondensation product of solvent.

33. The product according to claim 29 comprising less than 10000 ppm/wt of the solvent.

34. The process according to claim 19, wherein the catalytically active titanium compound is nano-structured titanium dioxide.

35. The process according to claim 23, wherein the inhibitor comprises a polyol.

36. The process according to claim 24, wherein the substrate is acylated polysaccharide.

37. The product according to claim 32, wherein the autocondensation product of solvent is diacetone alcohol.
